(19) United States
(12) Patent Application Publication
(10) Pub. No.: US 2004/0172312 A1
(43) Pub. Date: Sep. 2, 2004

(54) Method, system and storage medium for facilitating multi-party transactions

(76) Inventors: Ragui N. Selwanes, Edgewater, NJ (US); Nicholas J. Santoro, Avon, CT (US); Joseph C. Druzolowski, South Windsor, CT (US); Anna Mickiewicz, West Chester, PA (US)

Correspondence Address: CANTOR COLBURN LLP, 55 Griffin Road South, Bloomfield, CT, 06002, US

(21) Appl. No.: 10/383,485

(22) Filed: Mar. 7, 2003

Related U.S. Application Data
(63) Continuation-in-part of application No. 10/298,132, filed on Nov. 15, 2002.

(51) Int. Cl. G06F 17/60

(52) U.S. Cl. 705/4

(57) ABSTRACT

A method for facilitating multi-party transactions. A provider receives a provider card and the provider card is used to initialize services and to specify types of services. A member card is provided to members and used to obtain insurance information related to that member prior to a provider providing goods or services to the member. The provider card may then be used to obtain payment from the insurer. One or both of the provider card and the member card may be one of a credit card, debit card, stored value card and smart card that may be used for financial transactions as well.

### CROSS-REFERENCE TO RELATED APPLICATIONS

This application is a continuation-in-part of U.S. patent application Ser. No. 10/298,132 filed Nov. 15, 2002, the entire contents of which are incorporated herein by reference.

### BACKGROUND OF THE INVENTION

The invention relates generally to facilitating processing of multi-party transactions and may be applied in connection with claim verification eligibility and payment transactions involving insurers, benefit claim managers and administrators, covered individuals and vendors. Existing techniques for processing multi-party transactions are cumbersome. Take, for example, a patient visiting a doctor for a service such as a physical examination. In many cases, the patient has health insurance under which an insurer is obligated to pay for some portion of the doctor's fees. The doctor's office typically obtains a photocopy of the patient's insurance card so that claims may be submitted to the insurance company. The doctor provides the services and receives a co-payment from the patient. The doctor then bills the insurer for the balance and must wait for payment.

This process has a number of deficiencies. First, there is no confirmation from the insurer that the doctor is entitled to reimbursement from the insurer for rendering services to the patient. Patients may change insurance carriers or change plans and not be eligible for insurance coverage for certain services. The initial photocopy of the insurance card does not change as policy changes are made and thus there is no up-to-date information concerning the patient's eligibility and/or co-payment under the current insurance plan.

Another drawback to existing systems is the receipt of payment from the insurer. The typical process involves the provider submitting a claim to the insurer. The insurer then adjudicates the claim and determines whether the patient was eligible to receive the services under the applicable insurance policy. If so, the insurer determines the amount, if any, that is to be paid to the provider for rendering the services. This may be different than the amount requested from the provider. A check is sent by mail to the provider or an account maintained by the provider is funded electronically for the approved amount. If there is any excess amount unpaid by the insurer, the provider will then submit an invoice to the covered individual for the remainder. Typically, this is performed by mail and the individual remits payment by mail using a check.

The significant use of checks along with regular mail introduces significant delay into the process of determining benefits for the individual, remitting payment to the provider, invoicing the individual and receiving payment from the individual. Thus, a system that facilitates this process is needed.

### BRIEF SUMMARY OF THE INVENTION

An embodiment of the invention is a method for facilitating multi-party transactions. A provider receives a provider card and the provider card is used to initialize services and to specify types of services. A member card is provided to members and used to obtain insurance information related to that member prior to a provider providing goods or services to the member. The provider card may then be used to obtain payment. One or both of the provider card and the member card may be a credit card, debit card, stored value card or smart card that may be used for financial transactions as well.

### BRIEF DESCRIPTION OF THE DRAWINGS

FIG. 1 is a block diagram of an exemplary system for facilitating multi-party transactions;

FIG. 2 is a flowchart of an exemplary process for initializing a provider card;

FIG. 3 depicts an exemplary provider reference table;

FIG. 4 is a flowchart of an exemplary process for obtaining insurance information;

FIG. 5 is a flowchart of an exemplary process for obtaining payment; and

FIG. 6 is a block diagram of an exemplary system for facilitating multi-party transactions in an alternate embodiment.

### DETAILED DESCRIPTION OF THE PREFERRED EMBODIMENT

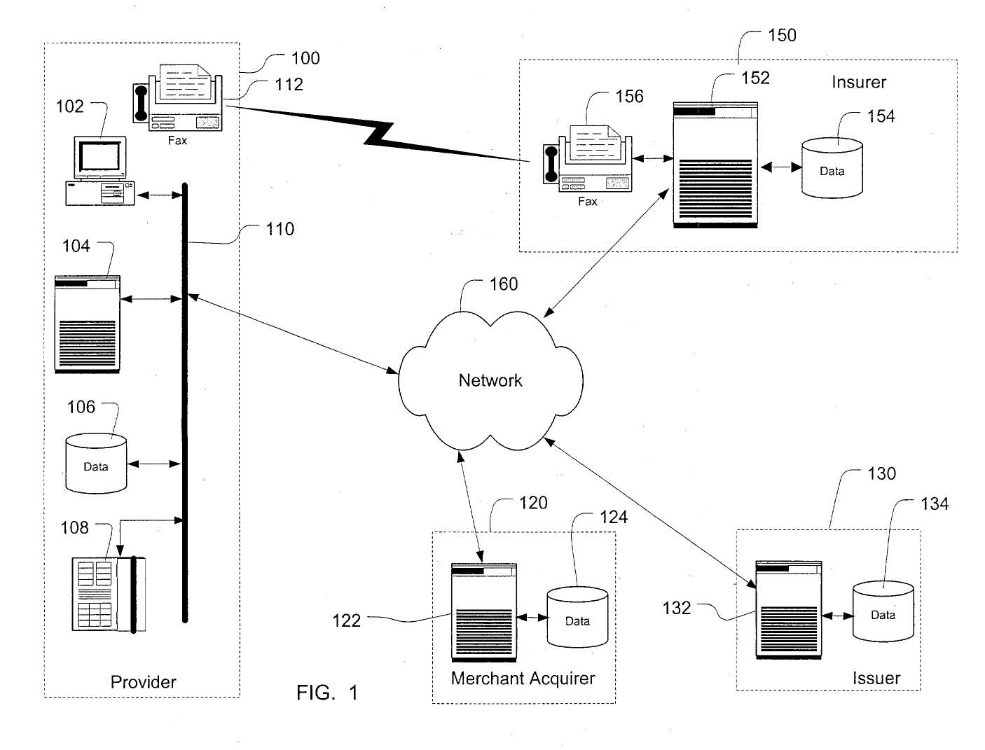

FIG. 1 is a block diagram of an exemplary system for facilitating multiparty transactions. The system includes a provider system 100 which, in one embodiment of the invention, is a health care provider. As described in further detail herein, the system may be utilized in a variety of multi-party goods/services transactions and is not limited to health care scenarios. Any transaction including a provider, an individual receiving goods/services and an insurer may be facilitated using embodiments of the invention. The provider system may include one or more workstations (e.g., personal computers) 102, a provider server 104, a provider storage device 106 and an input device 108 (e.g., a magnetic input device, bar code reader, keypad) all coupled to a provider network 110 (e.g., LAN, WAN). A provider facsimile component 112 may also be utilized to provide an alternate communication channel between an insurer and the provider. Although the provider facsimile component 112 is depicted as a separate device, it is understood that this component may be implemented by workstation 102 or server 104. The input device 108 may be an existing input device used to obtain information from credit cards, debit cards, stored value cards or smart cards.

The components in FIG. 1 are exemplary and it is understood that different components may be used to implement functions of described herein. For example, the functions of workstation 102, server 104, storage device 106 and facsimile component 112 may all be implemented on a single, personal computer. The phrase “provider system” is used herein to refer generally to system elements associated with the provider.

As described in further detail herein, the input device 108 is used to obtain member information from a member card. The member information is then routed over an open network to an insurer to determine insurance information such as eligibility information, co-payment information, benefits information, etc. This insurance information is then provided back to the provider system 100 over the open network. The input device 108 is also used to obtain provider information from a provider card when the provider wishes to initialize service or receive payment from the insurer. These processes are described in further detail herein.

The system also includes a merchant acquirer system 120 including a merchant acquirer server 122 and a merchant acquirer storage device 124. The merchant acquirer is typically the entity that provided the input device 108 to the provider contracted with the provider to accept any one or all of credit, debit, stored value card or smart cards. This may be the provider's bank or another financial institution.

An issuer system 130 includes an issuer server 132 and an issuer storage device 134. In conventional systems, the issuer is a bank that issues credit cards, debit cards stored value cards and/or smart cards conventionally used at input device 108 for payment to the provider.

An insurer system 150 may include an insurer server 152, an insurer storage device 154 and an insurer facsimile/e-mail component 156. Although the insurer facsimile/e-mail component 156 is depicted as a separate device, it is understood that this component may be implemented by server 152. Alternatively, the facsimile/e-mail component 156 may be operated by a third party separate from the insurer system in response to commands from the insurer system.

The insurer may correspond to various entities such as an insurance company or a benefit plan administrator. Thus, the term “insurer” as used herein is intended to include entities involved in the providing of insurance coverage or administration of benefits unless noted otherwise. Similarly, the term “insurance” as used herein is intended to include a variety of products and information related to insured or self-insured plans unless noted otherwise.

The insurer system 150 receives the member information, obtains insurance information based on the member information and provides insurance information to the provider system 100. As described in further detail herein, the insurance information (e.g., eligibility, co-payment, coordination of benefits (COB), etc.) may be provided to the provider system 100 in a number of ways.

The insurer system 150 may convert data from the input device 108 from a card format to an insurance format. For a debit card, credit card, stored value card or smart card, the card format is typically a 16 digit account identifier that is processed by the merchant acquirer system 120, an open network, optional third party processors and the issuer system 130. The insurer may not be able to process the 16 digit card format and thus insurance system 150, or some third party system, may convert the card format to an insurer format. This allows the insurer to access records relevant to the provider and the member.

The provider system 100, merchant acquirer system 120, issuer system 130 and insurer system 150 may be coupled via a network 160. The network 160 may be any type of known communication network including virtual private networks (VPN), the Internet, telephone service, and open network used in the financial industry or a combination of such networks. Appropriate security measures may be utilized such as encryption, secure socket layer (SSL), etc. Additionally, as described in further detail herein, the system employs verification techniques to activate input devices 108. Communication between the provider system 100 and insurer system 150 may occur directly or indirectly through merchant acquirer system 120, an open network and issuer system 130. In either case, the communication may also occur through one or more third party systems.

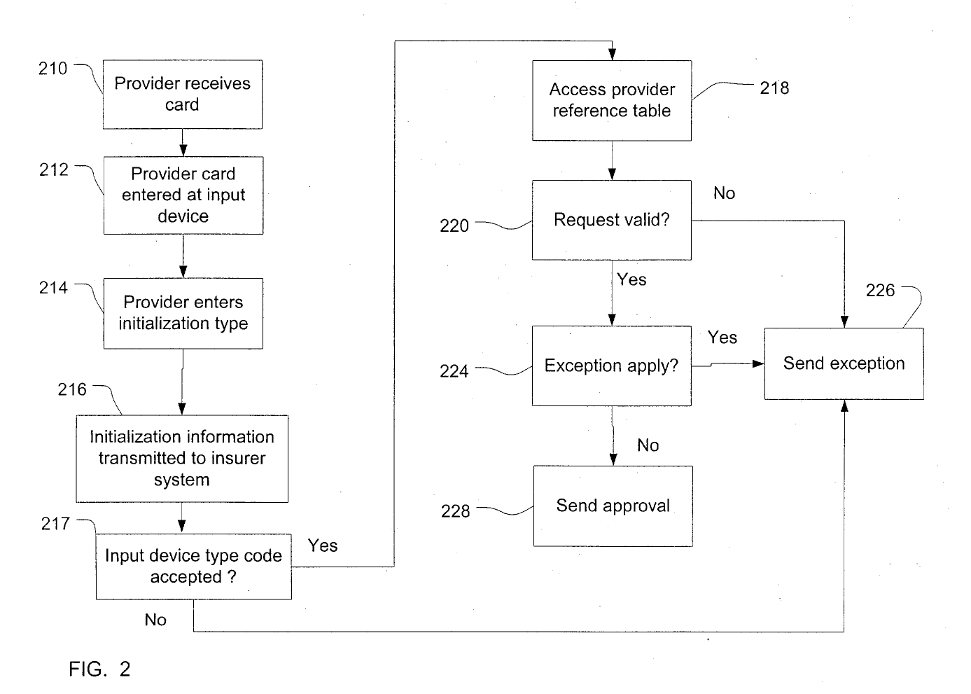

FIG. 2 is a flowchart of an exemplary process for a provider to register with insurer system 150 and to initiate a provider card for receiving payment from the insurer. The process begins at step 210 where the provider receives a provider card. The provider card may be a credit card, debit card, stored value card or smart card encoded with a provider identifier (e.g., a 16 digit code). The provider identifier is then entered using one or more input devices 108 (e.g., magnetic stripe read, barcode read, keyed in) to initialize use of the provider card with one or more input devices 108 at step 212. The provider also enters an initialization type at step 214 and selects a first function on the input device (e.g., pre-authorization). The initialization type indicates the type of initialization that the provider is requesting such as initialization to receive payment or initialization to receive insurance information via facsimile or e-mail. The initialization type may be defined by entering dollar amounts (e.g., $0.01 for payment initialization, $0.02 for facsimile/e-mail authorization, etc.).

Initialization information including a provider identifier from the provider card, input device identifier from input device 108 and initialization type is then transmitted, either directly or indirectly, to the insurer system 150 at step 216. This transmission typically occurs through the merchant acquirer system 120 over an open network and to the issuer system 130 depending on the communication ability between the provider system 100 and the insurer system 150. The issuer system 130 recognizes the initialization request based on the provider identifier (in card format) and the selection of the pre-authorization function. The issuer system 130 is programmed to route pre-authorization requests for this provider identifier to the insurer system 150.

At step 217 it is determined whether the input device type code is accepted. Exemplary existing credit card, debit card, stored value card or smart card systems assign a code such as a merchant category code (MCC) or a standard industry code (SIC) to vendors. This input device type code is transmitted when the input device 108 communicates with the merchant acquirer system 120. At step 217, the insurer system 150 determines whether the input device type code matches defined health care provider codes. If not, this indicates that the information has been entered at an input device that is not associated with a health care provider and the process flows to step 226.

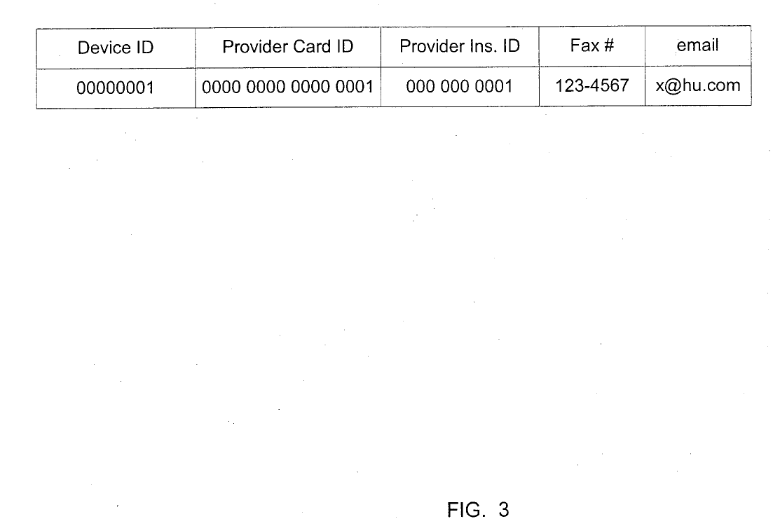

At step 218, the insurer system 150 then accesses a provider reference table such as that shown in FIG. 3. A provider reference table is accessed including the provider identifier in card format, provider identifier in insurer format, facsimile number and e-mail address. At step 220, it is determined whether the requested initialization is a valid request. If the received provider identifier does not match a provider identifier in the provider reference table or the initialization request does not include a valid initialization type, an exception message is sent to the input device at step 226.

If the provider identifier is valid (i.e., matches a provider identifier in the provider reference table) the device identifier is added to the provider reference table. This provider reference table may be stored on insurer storage device 154, on issuer storage device 134 and/or on a third party storage device. The provider reference table may be used to provide enhanced functionality when processing consumer eligibility transactions and when processing requests for payment from providers.

If the initialization request is considered valid, flow proceeds to step 224 where it is determined whether any exceptions apply. An exception may be detected based on multiple facsimile numbers linked to the same input device, the number of input devices associated with the provider exceeding a threshold, etc. If any exception is detected at step 224 or the request is not valid at step 220, then flow proceeds to step 226 where an exception message is sent to the input device 108. The exception message may be represented using the “referral” message used in existing credit card, debit card, stored value card or smart card readers. If an exception message is received, then an operator may contact the insurer to resolve initialization.

If the initialization request is valid and no exceptions apply, an approval is sent from the insurance system 150 to the input device 108 at step 228. Typically, this approval is transmitted through merchant acquirer system 120, open network and issuer system 130.

The above process allows providers, such as physicians, to initialize services such as receiving payment and receiving facsimile/e-mail notice of insurance information using existing infrastructure. The merchant acquirer system 120, open network and the issuer system 130 route initialization requests for provider cards to the insurer system 150. Thus, no new hardware is required at the provider's facility. Communication between systems may occur using open networks used in the financial industry eliminating the need for private, proprietary communication systems.

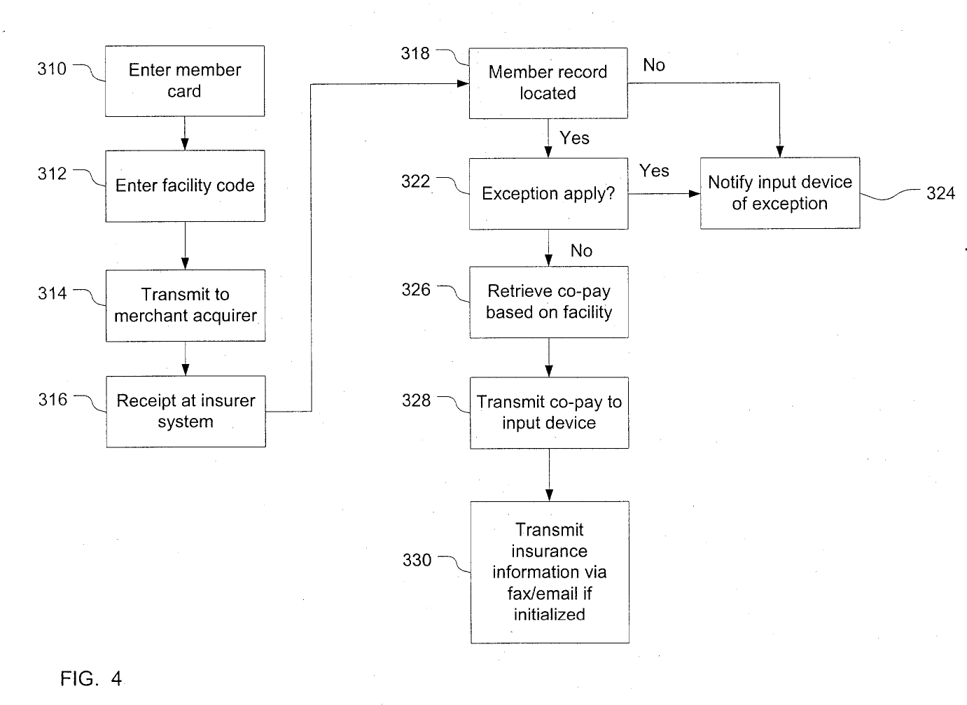

FIG. 4 is a flowchart of an exemplary process for facilitating the providing of services. The process begins at step 310 where a member identifier is entered at input device 108 (e.g., magnetic stripe read, barcode read, keyed in). In one embodiment, the member is a patient providing a member card at a health care provider. The system allows insurance information (e.g., eligibility) to be determined prior to rendering services. As noted above, the member card may be credit card, debit card, stored value card or smart card and encoded with information in a card format (e.g., 16 digit account number). At step 312, the operator selects a first function (e.g., pre-authorization) on the input device 108 and enters a financial amount identifying the type of provider facility. For example, the operator enters $0.01 for office visit, $0.02 for emergency room, etc.

At step 314, the input device 108 transmits, either directly or indirectly, a request for insurance information including the member identifier in the card format, the device identifier for the input device and the facility code to the insurer system 150. This transmission typically occurs through the merchant acquirer system 120, an open network and the issuer system 130 depending on the communication ability between the provider system 100 and the insurer system 150. The issuer system 130 recognizes the request for insurance information based on the member identifier (in card format) and the pre-authorization function. The issuer system 130 then forwards the request for insurance information, in an appropriate format, to the insurer system 150.

At step 316 the insurer system 150 receives the request for insurance information. The insurer system 150, or a third party system, may convert the member identifier from the card format to an insurer format if needed. At step 318, it is determined whether the member record is found in the database. If not, an exception message is sent to the input device 108 at step 324.

If the member record is found in the database, flow proceeds to step 322 where it is determined whether the member, the member's insurance group or member's benefit plan requires specific processing. Exemplary specific processing may include the requirement that the patient have a referral to visit the facility identified by the facility code in the insurance request. In such situations, flow proceeds to step 324 where an exception message is sent to the input device 108. The exception message may be represented using the “referral” message used in existing credit, debit, stored value or smart card readers. In this scenario, the provider may contact the insurer to clarify the scope of insurance coverage for the member.

If the member record is found in the member database and does not require specific processing, flow proceeds to step 326 where the appropriate co-payment is determined depending on the facility type submitted with the insurance request and the patient insurance plan. The varying co-payments are stored in the patient database on insurer storage device 154 or on a third party storage device. An approval code is sent to the input device 108 along with a numerical amount indicating the co-payment amount at step 328. The approval code may also be stored on the insurer storage device 154, the provider storage device 106 or on a third party storage system.

At step 330 an auxiliary transmission may occur if the provider has subscribed to this service. The insurer system or issuer system can initiate a facsimile and/or e-mail transmission from facsimile/e-mail component 156 to the provider if the provider has initialized these services as described above with reference to FIG. 2. The insurer system 150 locates the input device identifier in the provider reference table and determines if facsimile and/or e-mail notification has been initialized. If so, the insurer facsimile/e-mail component 156 sends a facsimile to provider facsimile component 112 and/or an e-mail to the provider system. The facsimile and/or e-mail may include an indication that the member is approved by the insurer to receive services, identification of the subscriber to the insurance plan and any dependents, coordination of benefit (COB) information, and a list of facility types and associated co-payments.

Once the approval and the co-payment amount is transmitted to the provider input device 108, the member may then pay the co-payment amount using the member card. In this scenario, the transaction is accomplished in the same manner as conventional credit, debit, stored value or smart card transactions. The member card is read at input device 108 and a second function (e.g., authorization transaction) is selected on the input device. The co-payment amount is transmitted to the merchant acquirer system 120, the open network and then to the issuer system 130 for financial processing. The issuer system recognizes this as a credit, debit, stored value or smart card transaction based on the second function (e.g., authorization) as contrasted with the first function (e.g., pre-authorization) which is used to identify the request for insurance information. This allows the member card to be used as a conventional credit, debit, stored value or smart card at other facilities.

In an alternate embodiment, the member card may be linked to a flexible spending or defined contribution account maintained by the member, member employer or plan sponsor. The input device 108 transfers the account information through the merchant acquirer system 120, open network to the issuer system 130 associated with an issuer that maintains the account.

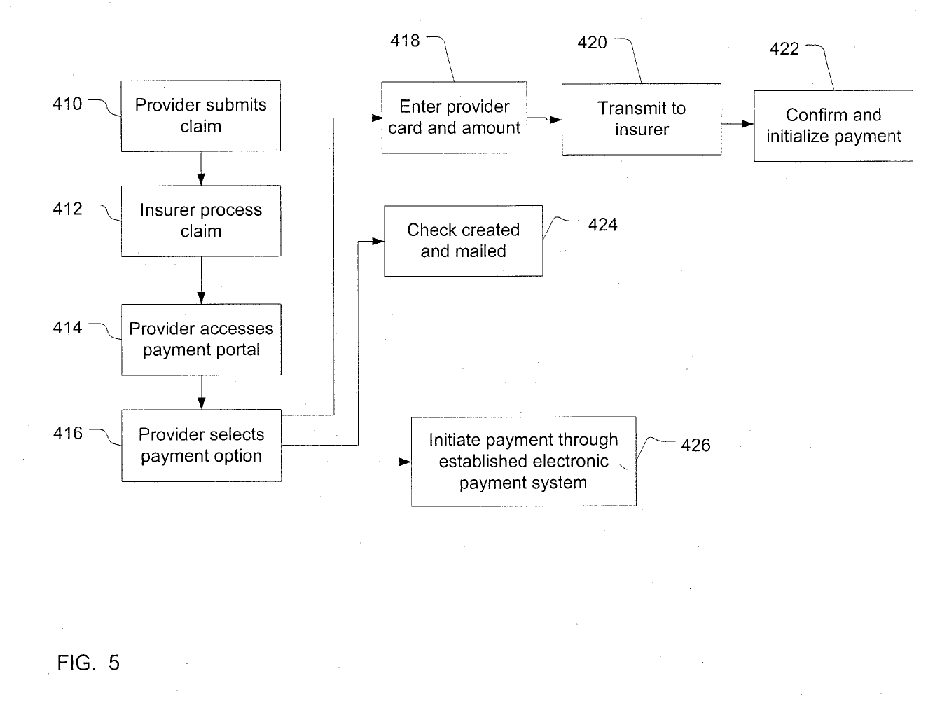

FIG. 5 is a flowchart of a process for a provider to receive payment from the insurer for services rendered to members. The process begins at step 410 where the provider submits a claim for payment to the insurer using existing techniques. The claim is processed at step 412 and the provider then accesses a payment portal (e.g., a secure web site) provided by the insurer at step 414. The payment portal lists authorized payments for the provider and may include an explanation of benefits related to the services provided by the provider.

Through the payment portal, the provider selects a way of receiving payment at step 416. Selecting a provider card payment option proceeds to step 418 where the provider reviews the authorized pending payments due to the provider. If the provider agrees with the amounts of the authorized pending payments, the provider then enters provider identifier through the input device 108 (e.g., magnetic stripe read, barcode read, keyed in) and enters a payment amount matching the amount of authorized pending payments from the portal and a second function (e.g., authorization transaction) is selected on the input device.

The provider identifier in card format, the payment amount, input device type code and the device identifier of the input device 108 are transmitted to the insurer system 150 at step 420 through the merchant acquirer system 120, open network and issuer system 130. The issuer system 130 recognizes the request for payment based on the provider account number on the provider card and input device function and input device type code and routes the request to the insurer system 150.

At step 422, the insurer system 150 confirms that the received provider identifier (in card format or insurer format) is associated with the received device identifier in the provider reference table shown in FIG. 3. This ensures that providers can only obtain payment from input devices 108 that were initialized with their personal card. Also, the amount received is compared to the amount of the authorized pending payments for that provider. If the provider identifier is not associated with the input device identifier or the amounts do not match, an exception message is sent to the input device. If the provider identifier is associated with the input device identifier and the amounts match, payment is authorized. The payment is then processed using existing credit card, debit card, stored value or smart card techniques (i.e., through issuer bank).

At step 416, the provider may also select to have payment made by check. In this scenario, at step 424 the insurer system 150 initiates a process to print and mail a check to the provider.

At step 416, the provider may also select to have payments made though existing electronic payment options such as electronic fund transfers (EFT) (e.g., automated clearing house (ACH) transfers). If so, flow proceeds to step 426 where payment is initiated. Using existing techniques, payment is made from the insurer to an account designated by the provider.

The provider may also use the provider card for credit, debit, stored value or smart card transactions. When the issuer system 130 receives authorization transactions based on the provider card, the issuer system evaluates the input device type code to determine whether the input device type code is associated with a health care provider. If so, the transaction is considered a request for payment to the provider and processed as described above with reference to FIG. 5. If the input device type code does not correspond to a health care provider, then the issuer system recognizes this transaction as a conventional credit, debit, stored value or smart card transaction and processes the transaction using known techniques. Of course, the issuer would have to enable this functionality.

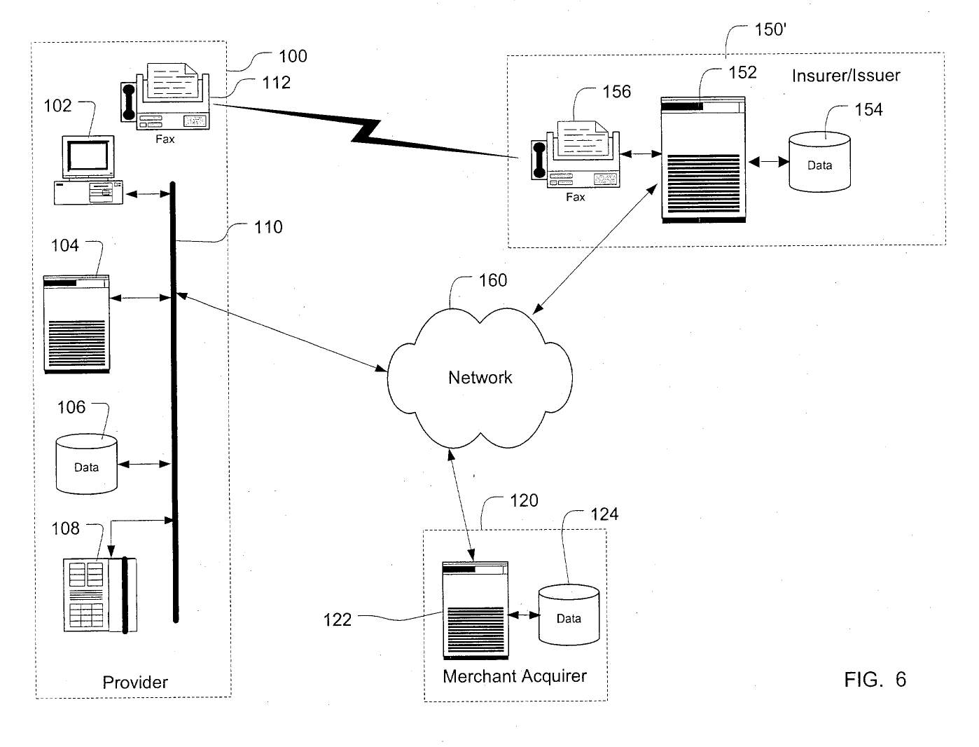

FIG. 6 is a block diagram of an exemplary system for facilitating multi-party transactions in an alternate embodiment. As shown in FIG. 6, the insurer system 150′ provides the functions of the insurer described above and serves as the issuer. The insurer issues the member card and provider card and processes transactions through insurer system 150′. As noted previously, the member card and provider card may be credit, debit, stored value or smart cards.

When the member card or the provider card information is entered through input device 108, or other input devices (e.g., at retail locations), the information is submitted to the insurer system 150′, either directly or through the merchant acquirer system 120 and open network. The insurer system 150′ determines if the transaction is (1) a provider requesting initialization of service, (2) a member obtaining eligibility information, (3) a provider requesting payment from the insurer, (4) a provider using the provider card for conventional credit, debit, stored value or smart card transactions or (5) a member using the member card for conventional credit, debit, stored value or smart card transactions. The insurer system 150′ detects these transactions using the same techniques described above with reference to the issuer system 130.

By serving as the card issuer, the insurer may then collect interchange fees associated with card-based transactions. Interchange fees are known in the field of credit card transactions. Briefly, the interchange fee is paid by the merchant acquirer to the issuer. The interchange fee compensates the issuer for the time after settlement with the merchant acquirer and before the issuer recoups the settlement value from the cardholder. The insurer, as issuer of the provider card and/or member card, collects interchange fees from the merchant acquirer when the provider card or the member card are used for conventional credit, debit, stored value or smart card transactions.

The interchange fee may be charged when the second function (e.g., authorization) is selected on an input device 108. This results in interchange fees being charged when the provider card is used to obtain payment, the provider card is used for financial transactions (e.g., retail sales) and the member card is used for financial transactions (e.g., paying co-payment or retail sales).

The system has been described in the context of facilitating processing of health care transactions but may be applied to a number of scenarios where member eligibility needs to be determined and payments distributed to providers. For example, the provider may be an auto body shop, the insurer an auto insurance provider or administrator and the member an individual having the auto insurance. Further, embodiments of the invention may be used regardless of the whether goods or services are provided to the member. Thus, the embodiments disclosed herein are exemplary.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/ or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A method for processing provider transactions, the method comprising:
an insurer providing a provider with a provider card encoded with a provider identifier;
the insurer receiving an initialization request over an open network from a provider input device, the initialization request including the provider identifier, an input device identifier and an initialization type;
the insurer processing the initialization request including determining if the provider identifier exists in a provider reference table and updating the provider reference table to include the input device identifier if the provider identifier exists in the provider reference table;
the insurer charging an interchange fee to a merchant acquirer when the provider card is used for a financial transaction.

2. The method of claim 1 further comprising:
the insurer transmitting an exception message to the input device if the provider identifier exists in a provider reference table and an exception condition exists with respect to the initialization request, the exception condition corresponding to multiple facsimile numbers associated with the input device.

3. The method of claim 1 further comprising:
the insurer transmitting an exception message to the input device if the provider identifier exists in a provider reference table and an exception condition exists with respect to the initialization request, the exception condition corresponding to a number of input devices associated with the provider identifier exceeding a threshold.

4. The method of claim 1 wherein the initialization request includes an input device type code; the method further comprising transmitting an exception message to the input device if the input device type code does not match at least one reference type code.

5. The method of claim 1 wherein the initialization request is a request to transmit insurance information to the provider via facsimile.

6. The method of claim 1 wherein the initialization request is a request to transmit insurance information to the provider via e-mail.

7. The method of claim 1 wherein the provider card is at least one of a credit card, debit card, stored value card and smart card.

8. The method of claim 7 wherein the initialization request is transmitted from the provider input device via the merchant acquirer over the open network and to the insurer.

9. The method of claim 8 wherein the initialization request is recognized over the open network by the insurer in response to the provider identifier and a function selected on the input device.

10. A method for processing provider transactions, the method comprising:
an insurer providing a provider with a provider card encoded with a provider identifier;
the insurer receiving a payment request over an open network from a provider input device, the payment request including the provider identifier, an input device identifier and a payment amount;
the insurer processing the payment request including determining if the provider identifier exists in a provider reference table and is associated with the input device identifier;
the insurer transmitting an exception message to the input device if the provider identifier does not exist in the provider reference table or if the provider identifier is not associated with the input device identifier;
the insurer approving the payment request if the provider identifier exists in the provider reference table and is associated with the input device identifier;
the insurer initiating payment to an account associated with the provider card, the provider card being at least one of a credit card, debit card, stored value card and smart card;
the insurer charging an interchange fee to a merchant acquirer when the provider card is used for a financial transaction.

11. The method of claim 10 wherein the payment request includes a requested payment amount, the approving the payment request includes determining if the requested payment amount matches an approved payment amount established by the insurer.

12. The method of claim 10 wherein the payment request is transmitted over the open network from the provider input device via a merchant acquirer to the insurer.

13. The method of claim 12 wherein the payment request includes an input device type code, the payment request is recognized by one of the merchant acquirer and insurer in response to the provider identifier and the input device type code.

14. A method for processing provider transactions, the method comprising:
an insurer providing a provider with a provider card encoded with a provider identifier;
the insurer receiving an initialization request over an open network from a provider input device, the initialization request including the provider identifier, an input device identifier and an initialization type;
the insurer processing the initialization request including determining if the provider identifier exists in a provider reference table and updating the provider reference table to include the input device identifier if the provider identifier exists in the provider reference table;
the insurer transmitting an exception message to the input device if the provider identifier does not exist in the provider reference table;
the insurer receiving a payment request over an open network from a provider input device, the payment request including the provider identifier, an input device identifier and a payment amount;
the insurer processing the payment request including determining if the provider identifier exists in a provider reference table and is associated with the input device identifier;
the insurer transmitting an exception message to the input device if the provider identifier does not exist in the provider reference table or if the provider identifier is not associated with the input device identifier;
the insurer approving the payment request if the provider identifier exists in the provider reference table and is associated with the input device identifier;
the insurer initiating payment to an account associated with the provider card, the provider card being at least one of a credit card, debit card, stored value card and smart card; and
the insurer charging an interchange fee to a merchant acquirer when the provider card is used for a financial transaction.
